(19) United States
(12) Patent Application Publication
(10) Pub. No.: US 2008/0282034 A1
(43) Pub. Date: Nov. 13, 2008

(54) Memory Subsystem having a Multipurpose Cache for a Stream Graphics Multiprocessor

(75) Inventors: Yang (Jeff) Jiao, San Jose, CA (US); Yiping Chen, San Jose, CA (US); Timour Paltashev, Laveen, AZ (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 12/175,560

(22) Filed: Jul. 18, 2008

Related U.S. Application Data
(63) Continuation-in-part of application No. 11/229,939, filed on Sep. 19, 2005.

(51) Int. Cl. G06F 12/00

(52) U.S. Cl. 711/125; 711/E12.051

(57) ABSTRACT

A method and a computing system are provided. The computing system may include a system memory configured to store data in a first data format. The computing system may also include a computational core comprising a plurality of execution units (EU). The computational core may be configured to request data from the system memory and to process data in a second data format. Each of the plurality of EU may include an execution control and datapath and a specialized L1 cache pool. The computing system may include a multipurpose L2 cache in communication with the each of the plurality of EU and the system memory. The multipurpose L2 cache may be configured to store data in the first data format and the second data format. The computing system may also include an orthogonal data converter in communication with at least one of the plurality of EU and the system memory.

### CROSS-REFERENCE TO RELATED APPLICATIONS

This application is a continuation-in-part of a copending U.S. utility application entitled “Buffering Missed Requests in Processor Caches,” having Ser. No. 11/229,939, filed Sep. 19, 2005 and published as U.S. Pat. App. Pub. No. 2007/0067572, which is hereby incorporated by reference in its entirety.

This application incorporates by reference, in their entireties, the following other co-pending U.S. patent applications, also filed on Sep. 19, 2005:

U.S. patent application Ser. No. 11/229,808, entitled “Selecting Multiple Threads for Substantially Concurrent Processing” and published as U.S. Pat. App. Pub. No. 2007/0067607; and U.S. patent application Ser. No. 11/229,884, entitled “Merging Entries in Processor Caches” and published as U.S. Pat. App. Pub. No. 2007/0067567.

### FIELD OF THE DISCLOSURE

The present disclosure relates generally to stream processors and, more particularly, to caches associated with stream processors.

### BACKGROUND

Increasing complexity in software applications, such as in graphics processing, has led to an increasing demand for hardware processing power. To improve processing efficiency, modern-day processing architectures for memory subsystems may include multiple caches. In stream graphics processing applications, the caches may serve as a part of virtual pipeline providing data communication between different clients processing data in sequential stages of stream data processing. The caches may be located within the processing unit itself or may be shared among multiple processing units implemented on the same silicon die. These configurations may permit faster access to data and, consequently, enable faster processing.

While various cache configurations for memory subsystems have been developed, improved configurations may be useful for modern stream graphics data processing applications where the memory subsystem supports a virtual stream processing pipeline in addition to conventional functions.

### SUMMARY

Systems and methods are described in the present disclosure for processing graphics data and storing graphics data in a cache system. In one embodiment, among others, a computing system may be provided. The computing system may include a system memory configured to store data in a first data format. The computing system may also include a computational core comprising a plurality of execution units (EU). The computational core may be configured to request data from the system memory and to process data in a second data format. Each of the plurality of EU may include an execution control and datapath and a specialized L1 cache pool for storing data in the first data format and the second data format. Further, the computing system may include a multipurpose L2 cache in communication with the each of the plurality of EU and the system memory. The multipurpose L2 cache may be configured to store data in the first data format and the second data format. The computing system may also include an orthogonal data converter in communication with at least one of the plurality of EU and the system memory. The orthogonal data converter may be configured to convert data sent to and from the execution control and datapath.

In another embodiment, among others, a method may be provided. The method may include receiving a data request from an execution control and datapath that may be configured to process data in a first data format. An execution unit may include the execution control and datapath and a specialized L1 cache pool associated with the execution control and datapath. The method may further include determining whether the received data request results in a hit on a multipurpose L2 cache. The multipurpose L2 cache may being configured to store data in the first data format and a second data format. The method may include storing information related to the received data request in an entry in a missed request table in response to determining that the received data request does not result in a hit on the multipurpose L2 cache. Also, the method may include servicing the data request in response to determining that the received data request results in a hit on the cache. Servicing the data request may further include orthogonally converting requested data related the received data request.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a diagram illustrating an exemplary nonlimiting computing system.

FIG. 1B is a block diagram illustrating an exemplary flow of data in an embodiment of a stream graphics processor with a memory subsystem.

FIG. 1C is a block diagram showing an example processor environment.

FIG. 2 is a block diagram showing components within the computational core of FIG. 1C.

FIG. 3 is a block diagram showing the level-2 (L2) cache of FIG. 2 in greater detail.

FIG. 4 is a block diagram showing components within the L2 cache of FIG. 3.

FIG. 5 is a block diagram showing several of the components of FIGS. 3 and 4 in greater detail.

FIG. 6 is an illustration of an L2 tag and data structure.

FIG. 7 is an illustration of a structure for an entry in a missed read-request table.

FIG. 8 is an illustration of a structure for an entry in a missed write-request table.

FIG. 9 is an illustration of a structure for an entry in a return data buffer.

FIG. 10 is an illustration of a structure for an entry in a return request queue.

FIG. 11 is an illustration of an exemplary embodiment of a method.

### DETAILED DESCRIPTION OF THE EMBODIMENTS

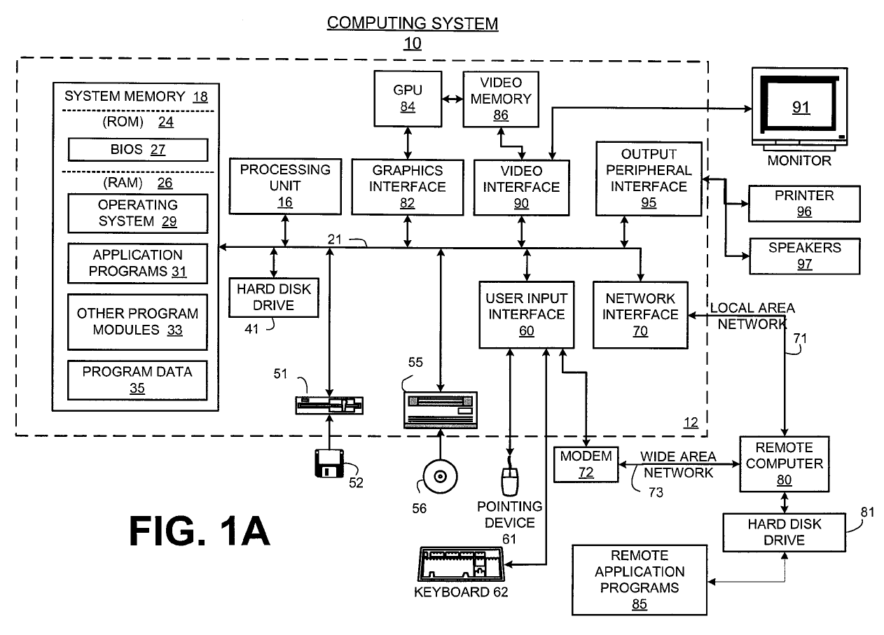

FIG. 1A is a diagram illustrating an exemplary nonlimiting computing system 10 that includes a computer 12. The components of the computer 12 may include, as nonlimiting examples, a processing unit 16, a system memory 18, and a system bus 21 that couples various system components, including the system memory 18, to the processing unit 16. The system bus 21 may be any of several types of bus structures, as one of ordinary skill in the art would know, including a memory bus or memory controller, a peripheral bus, and a local bus using any of a variety of bus architectures. As a nonlimiting example, such architectures may include a peripheral component interconnect (PCI) bus, accelerated graphics port (AGP), and/or PCI Express bus.

Computer 12 may include a variety of computer readable media. Computer readable media can be any available media that can be accessed by computer 12 and includes both volatile and nonvolatile memory, which may be removable, or nonremovable memory.

The system memory 18 may include computer storage media in the form of volatile and/or nonvolatile memory, such as read only memory (ROM) 24 and random access memory (RAM) 26. A basic input/output system 27 (BIOS) may be stored in ROM 24. As a nonlimiting example, operating system 29, application programs 31, other program modules 33, and program data 35 may be contained in RAM 26.

Computer 12 may also include other removable/nonremovable volatile/nonvolatile computer storage media. As a nonlimiting example, a hard disk drive 41 may read from or write to nonremovable, nonvolatile magnetic media. A magnetic disk drive 51 may read from or write to a removable, nonvolatile magnetic disk 52. An optical disk drive 55 may read from or write to optical disk 56.

A user may enter commands and information into computer 12 through input devices such as keyboard 62 and pointing device 61, which may be coupled to processing unit 16 through a user input interface 60 that is coupled to system bus 21. However, one of ordinary skill in the art would know that other interface and bus structures such as a parallel port, game port, or a universal serial bus (USB) may also be utilized for coupling these devices to the computer 12.

A monitor 91 or other type of display device may be also coupled to system bus 21 via a video interface 90. In addition to monitor 91, computer system 10 may also include other peripheral output devices, such as printer 96 and speakers 97, which may be coupled via output peripheral interface 95.

Computer 12 may operate in networked or distributed environments using logical connections to one or more remote computers, such as remote computer 80. Remote computer 80 may be a personal computer, a server, a router, a network PC, a pier device, or other common network node. Remote computer 80 may also include many or all of the elements described above in regard to computer 12, even though only memory storage device 81, for example another hard disk drive, and remote application programs 85 are depicted in FIG. 1A. The logical connections depicted in FIG. 1A include a local area network (LAN) 71 and a wide area network (WAN) 73, but may include other network/buses.

In this nonlimiting example of FIG. 1A, remote computer 80 may be coupled to computer 12 via LAN connection 71 and network interface 70. Likewise, a modem 72 may be used to couple computer 12 (via user input interface 60) to remote computer 80 across WAN connection 73.

The computer 12 may also include one or more graphics processing units (GPUs) 84 that may communicate with the graphics interface 82 that is coupled to system bus 21. Also, GPU 84 may also communicate with a video memory 86, as desired.

In some embodiments, the GPU 84 may include a stream graphics multiprocessor, and the computer 12 may include a memory subsystem for the stream graphics processor. The memory subsystem may have a hierarchical arrangement of storage, including multiple caches, a system memory, buffers, etc., called a memory hierarchy. A cache may be a small and fast memory that may hold recently accessed data, and a cache may be designed to speed up subsequent access to the same data. For example, when data is read from or written to system memory 18, a copy may also be saved in the cache, along with the associated system memory 18 address. The cache may monitor addresses of subsequent reads to see if the required data is already in the cache. If the data is in the cache (referred to as a “cache hit”), then it may be returned immediately and a read of the system memory 18 may be aborted or not started. If the data is not in the cache (referred to as a “cache miss”), then the data may be fetched from system memory 18 and also saved in the cache.

Further, a cache may be built from faster memory chips than system memory 18, so that a cache hit may take less time to complete than a system memory 18 access. In addition, a cache may be located on the same integrated circuit as the processing unit 16 to reduce access time. Those caches that are located on the same integrated circuit as the processing unit 16 may be referred to as a primary cache or a level-1 (L1) cache. Caches that are located outside the integrated circuit may be larger and slower caches, and those caches may be referred to as level-2 (L2) caches. For certain architectures, such as the ones disclosed herein, multiple caches may be located on the same integrated circuit as the stream graphics processor of the GPU 84.

FIG. 1B illustrates a logical view of one nonlimiting example of the flow of data in an exemplary stream graphics processor and a memory subsystem of a computing system. This flow may provide efficient processing of graphics data using one or more execution units 240a, 240b. In the nonlimiting example shown in FIG. 1B, two execution units 240a, 240b are illustrated, but more execution units may be implemented than shown. Each execution unit 240a may include an execution control and datapath 150a as well as a specialized L1 cache pool 155a. The execution control and datapath 150a may be replicated several times to provide a performance matching to accommodate application demands. Also, the execution control and datapath 150a may include a Single Instruction, Multiple Data (SIMD) superscalar processing core. The SIMD superscalar processing core may be fully programmable and/or may provide significant processing power. A nonlimiting example of a SIMD superscalar processing core may be described in U.S. Pat. No. 7,146,486 issued to Prokopenko et al. and entitled “SIMD Processor with Scalar Arithmetic Logic Units,” which is hereby incorporated by reference in its entirety.

Further, the SIMD superscalar processing core may be capable of processing data in the horizontal and/or vertical data formats, and it may be configured to implement a foldable (variable) SIMD factor allowing the processing core to process data in a vertical or horizontal mode depending on the instruction being executed. A nonlimiting example of a SIMD superscalar processing core implementing such a factor is described in U.S. Pat. Pub. No. 2007/0186082 to Prokopenko et al. and entitled “Stream Processor with Variable Single Instruction Multiple Data (SIMD) Factor and Common Special Function,” which is hereby incorporated by reference in its entirety.

The memory subsystem may include a hierarchical arrangement of storage called a memory hierarchy. The memory hierarchy may include a specialized L1 cache pool 155a, a vertex cache 160a, a multipurpose L2 cache 210, a system memory 18, a frame buffer (also referred as video memory) 86, a DMA block 180 and/or orthogonal converters 185, 186. The specialized L1 cache pool 155a may include specialized L1 caches such as, in this nonlimiting example, a constants cache 157a, a temporary register 156a, an instructions cache 161a, a texture (t#) descriptor and sampler (s#) descriptor cache 158a, and/or a vertices cache 162a.

One or more of the specialized L1 cache pools 155a, 155b may be associated with one or more of the execution control and datapaths 150a, 150b. In some embodiments, such as the nonlimiting example illustrated in FIG. 1B, one specialized L1 cache pool 155a may be associated with one execution control and datapath 150a. The specialized L1 cache pool 155a and the associated execution control and datapath 150a may be a nonlimiting example of an execution unit (EU) 240a. The stream graphics processor may include multiple EUs 240a, 240b, and in the nonlimiting example illustrated in FIG. 1B, two EUs 240a, 240b are illustrated. However, more than two EUs 240a, 240b may be implemented.

The memory subsystem may be complex and may offer additional functionality beyond that of other memory subsystems supporting traditional CPUs. An additional function may be support of two different types of data formats (e.g. layouts). For example, the system memory 18 may contain input graphics data in a linear (horizontal) format, which is native for the CPU that prepares this data for further processing by the stream graphics processor. In the linear (horizontal) format, data entities (e.g., vertices) may be arranged as structures within a one-dimensional array (e.g., V1.xyzwrgba, V2.xyzwrgba, etc.). The linear (horizontal) format may also be referred to as a vector format. In contrast, the vertical superscalar format may be native for the execution control and datapath 150a, and data may be arranged as a two-dimensional array with packets containing data items from multiple entities (e.g., (V1.x, V2.x, . . . Vn.x), (V1.y, V2.y, . . . Vn.y), etc.). This data format may be processed as a packet of scalars and may be stored in the memory subsystem in this format as well.

Also included in the memory subsystem may be input and output orthogonal converters 185, 186 to provide mutual format conversion from a horizontal data format to a vertical data format and/or conversion from a vertical format to a horizontal data format. Nonlimiting examples of orthogonal converters 185, 186 may be described in the following references, which are hereby incorporated by reference in their entirety: U.S. Pat. No. 7,284,113 issued to Prokopenko et al. and entitled “Synchronous Periodical Orthogonal Data Converter” and U.S. Pat. No. 7,146,486 issued to Prokopenko et al. and entitled “SIMD Processor with Scalar Arithmetic Logic Units.”

Also, the L1 caches in the specialized L1 cache pool 155a may contain data in the vertical and/or horizontal data formats depending on the specialization of the L1 cache. Also, the temporal register cache 156a may have vertical format data, whereas the constants cache 157a and/or the texture descriptor (t#) and sampler descriptor (s#) 158a cache may have data in both formats. Also, the vertex L1 cache 162a, which may serve as an input and interstage buffer, may have both types of data formats as well. The frame buffer 86, the multipurpose L2 cache 210 and/or some of the L1 caches (e.g., cache 155a) in the specialized L1 cache pool 155a may be capable of storing data in both types of formats. The multipurpose L2 cache 210 may contain any data with any format fetched from system memory 18 or spilled from the specialized L1 caches 155a of the execution control and datapaths 150a. Also, the multipurpose L2 cache 210 may be common to other components whereas the specialized L1 caches 155a, 155b are associated with certain execution control and datapaths 150a, 150b.

In some embodiments, the multipurpose L2 cache 210 may also serve as a virtual extension buffer for the constants cache 157a and/or temporal register cache 156a in the specialized L1 cache pool 155a. The constants cache 157a and/or temporal register cache 156a may be indexed by the execution control and datapath 150a and may be directly accessed by the execution control and datapath 150a. These virtual extension buffers may be flexibly arranged in a variety of shapes and may accommodate some of the growing demands of graphics programmability. The virtual extension buffers may include vertical data formats which are the native format for the constants cache 157a and/or temporal register cache 156a. Also, the multipurpose L2 cache 210 may save data in both the vertical format and/or the horizontal format and may provide indexing support for large scale virtual extension buffers, which may be useful for improving stream graphics processing performance.

Further, another exemplary additional function may be support of two different types of data formats for the buffers in the frame buffer 86: linear horizontal buffers 176 and vertical superscalar buffers 177. The data stored in the linear horizontal buffers 176 may be stored in a horizontal format, and the data stored in the vertical superscalar buffers 177 may be stored in a vertical format. The graphics data format in the linear horizontal buffers 171 may not be compatible with the data format of the execution control and datapath 150a, which may process data in a vertical data format. The data in the linear horizontal buffers 171 may be orthogonally converted by an orthogonal converter 185 before the data is applied to the execution control and datapath 150a. The data also may be orthogonally converted back by another orthogonal converter 186 to buffer intermediate results in the frame buffer 86 or the system memory 18.

By supporting different types of data formats, the memory subsystem may improve the processing performance in a complex virtual pipeline with multiple clients mapped to parallel stream processors in a MIMD (Multiple Instruction Multiple Data) configuration. These clients may have different data formats native to the system memory 18 and execution control and datapath 150a. The memory subsystem including these multiple caches may be able to accommodate and orthogonally convert both horizontal and vertical data formats while providing minimal access latency for the EUs 240a, 240b. Further, the memory subsystem may support input and inter-stage buffering for the virtual pipeline, spill and prefetch data for L1 caches as well as provide indexed random access to a memory location directly from execution control and datapath 150a.

FIG. 1C is a block diagram showing an example processor environment for a stream graphics processor. While not all components for graphics processing are shown, the components shown in FIG. 1C should be sufficient for one having ordinary skill in the art to understand the general functions and architecture related to such stream graphics processors. At the center of the processing environment is a computational core 105, which processes various instructions and which includes one or more EUs and a multipurpose L2 cache. That computational core 105, for multi-issue processors, is capable of processing multiple instructions within a single clock cycle.

As shown in FIG. 1C, the relevant components of the stream graphics processor include the computational core 105, a texture filtering unit 110, a pixel packer 115, a command stream processor 120, a write-back unit 130, and a texture address generator 135. Also included in FIG. 1C is an EU pool control unit 125, which also includes a vertex cache and/or a stream cache. The computational core 105 receives inputs from various components and outputs to various other components.

For example, as shown in FIG. 1C, the texture filtering unit 110 provides texel data to the computational core 105 (inputs A and B). For some embodiments, the texel data is provided as 512-bit data, thereby corresponding to the data structures defined below.

The pixel packer 115 provides pixel shader inputs to the computational core 105 (inputs C and D), also in 512-bit data format. Additionally, the pixel packer 115 requests pixel shader tasks from the EU pool control unit 125, which provides an assigned EU number and a thread number to the pixel packer 115. Since pixel packers and texture filtering units are known in the art, further discussion of these components is omitted here. While FIG. 1C shows the pixel and texel packets as 512-bit data packets, it should be appreciated that the size of the packets can be varied for other embodiments, depending on the desired performance characteristics of the graphics processor.

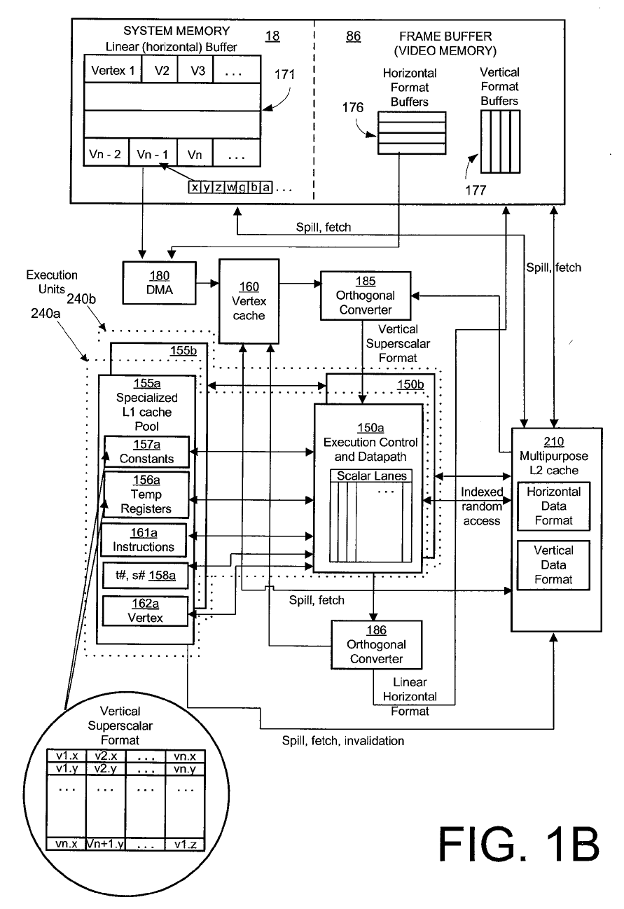

The command stream processor 120 provides triangle vertex indices to the EU pool control unit 125. In the embodiment of FIG. 1C, the indices are 256-bits. The EU pool control unit 125 assembles vertex shader inputs from the stream cache and sends data to the computational core 105 (input E). The EU pool control unit 125 also assembles geometry shader inputs and provides those inputs to the computational core 105 (input F). The EU pool control 125 also controls the EU input 235 and the EU output 225 as shown in FIG. 2. In other words, the EU pool control 125 controls the respective inflow and outflow to the computational core 105.

Upon processing, the computational core 105 provides pixel shader outputs (outputs J1 and J2) to the write-back unit 130. The pixel shader outputs include red/green/blue/alpha (RGBA) information, which is known in the art. Given the data structure in the disclosed embodiment, the pixel shader output is provided as two 512-bit data streams.

Similar to the pixel shader outputs, the computational core 105 outputs texture coordinates (outputs K1 and K2), which include UVRQ information, to the texture address generator 135. The texture address generator 135 issues a texture request (T# Req) to the computational core 105 (input X), and the computational core 105 outputs (output W) the texture data (T# data) contained in the multipurpose L2 cache 210 to the texture address generator 135. Since the various examples of the texture address generator 135 and the write-back unit 130 are known in the art, further discussion of those components is omitted here. Again, while the UVRQ and the RGBA are shown as 512 bits, it should be appreciated that this parameter may also be varied for other embodiments. In the embodiment of FIG. 1C, the bus is separated into two 512-bit channels, with each channel holding the 128-bit RGBA color values and the 128-bit UVRQ texture coordinates for four pixels.

The computational core 105 and the EU pool control unit 125 also transfer to each other 512-bit vertex cache spill data. Additionally, two 512-bit vertex cache writes are output from the computational core 105 (outputs M1 and M2) to the EU pool control unit 125 for further handling.

Having described the data exchange external to the computational core 105 in FIG. 1C, attention is turned to FIG. 2, which shows a block diagram of various components within the computational core 105. As shown in FIG. 2, the computational core 105 comprises a memory access unit (MXU) 205 that is coupled to the multipurpose L2 cache 210 through a memory interface arbiter 245.

The multipurpose L2 cache 210 may receive vertex cache spill (input G) from the EU pool control unit 125 and may provide vertex cache spill (output H) to the EU pool control unit 125. Additionally, the multipurpose L2 cache 210 may receive T# requests (input X) from the texture address generator 135, and may provide the T# data (output W) to the texture address generator 135 in response to the received request.

The memory interface arbiter 245 provides a control interface to the local video memory (frame buffer) 86. While not shown, a bus interface unit (BIU) provides an interface to the system through, for example, a PCI express bus. The memory interface arbiter 245 and BIU provide the interface between the video memory 86 and multipurpose L2 cache 210. For some embodiments, the EU pool connects multipurpose L2 cache to the memory interface arbiter 245 and the BIU through the memory access unit 205. The memory access unit 205 translates virtual memory addresses from the L2 cache 210 and other blocks to physical memory addresses.

The memory interface arbiter 245 may provide memory access (e.g., read/write access) for the multipurpose L2 cache 210, fetching of instructions/constants/data/texture, direct memory access (e.g., load/store), indexing of temporary storage access, register spill, vertex cache content spill, etc.

The computational core 105 also comprises an EU pool 230, which includes multiple EUs 240a . . . 240h (collectively referred to herein as 240), each of which includes an EU control and local memory (not shown). Each of the EUs 240 are capable of processing multiple instructions within a single clock cycle. Thus, the EU pool 230, at its peak, can process multiple threads substantially simultaneously. These EUs 240, and their substantially concurrent processing capacities, are described in greater detail below. While eight (8) EUs 240 are shown in FIG. 2 (labeled EU0 through EU7), it should be appreciated that the number of EUs need not be limited to eight, but may be greater or fewer in number for other embodiments.

The computational core 105 may further comprise an EU input 235 and an EU output 225, which may be respectively configured to provide the inputs to the EU pool 230 and receive the outputs from the EU pool 230. The EU input 235 and the EU output 225 may be crossbars or buses or other known input mechanisms.

The EU input 235 receives the vertex shader input (E) and the geometry shader input (F) from the EU pool control 125 (FIG. 1B), and provides that information to the EU pool 230 for processing by the various EUs 240. Additionally, the EU input 235 receives the pixel shader input (inputs C and D) and the texel packets (inputs A and B), and conveys those packets to the EU pool 230 for processing by the various EUs 240. Additionally, the EU input 235 receives information from multipurpose L2 cache 210 (L2 read) and provides that information to the EU pool 230 as needed.

The EU output 225 in the embodiment of FIG. 2 is divided into an even output 225a and an odd output 225b. Similar to the EU input 235, the EU output 225 can be crossbars or buses or other known architectures. The even EU output 225a handles the output from the even EUs 240a, 240c, 240e, 240g, while the odd EU output 225b handles the output from the odd EUs 240b, 240d, 240f, 240h. Collectively, the two EU outputs 225a, 225b receive the output from the EU pool 230, such as the UVRQ and the RGBA. Those outputs, among others, may be directed back to multipurpose L2 cache 210, or output from the computational core 105 to the write-back unit 130 through J1 and J2 or output to the texture address generator 135 through K1 and K2.

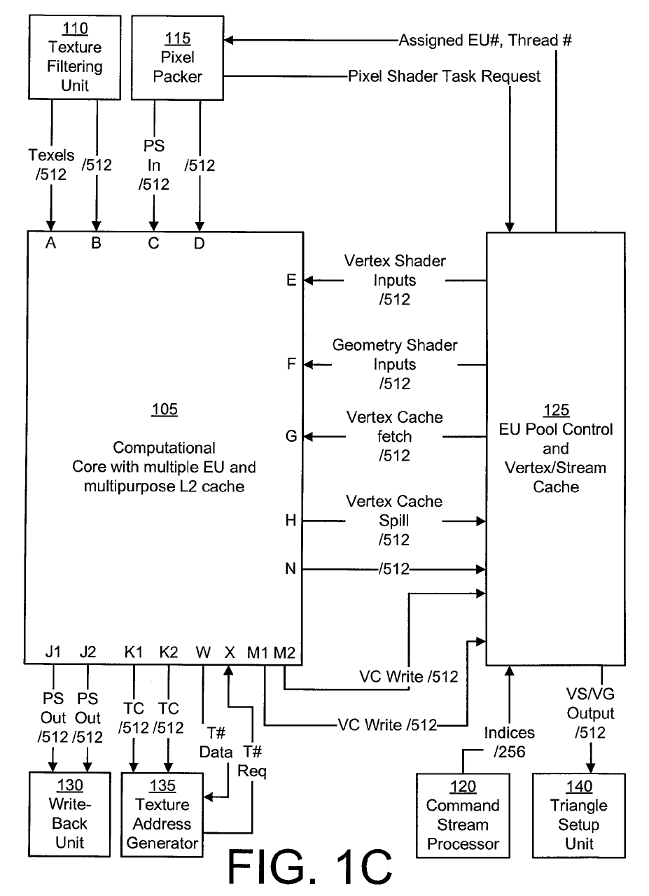

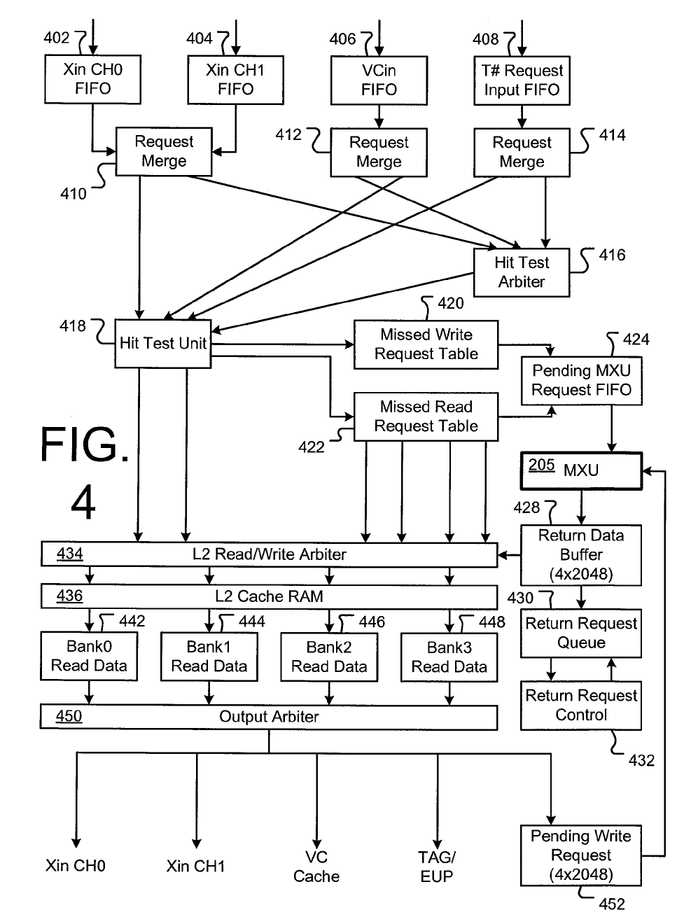

FIG. 3 is a block diagram showing the multipurpose L2 cache 210 of FIG. 2 in greater detail. For some embodiments, the multipurpose L2 cache 210 uses four banks of 1 RW 512×512-bit memories, and the total size of the cache is 1M-bits. In the embodiment of FIG. 3, multipurpose L2 cache 210 has 512 cache lines, and the line size is 2048 bits. The cache line is divided into four 512-bit words, each on a different bank. In order to access the data, an addressing scheme is provided, which designates the proper virtual memory address space for the respective data. An example data structure for the multipurpose L2 cache 210 is provided with reference to FIG. 6.

For some embodiments, the address may have a 30-bit format that is aligned to 32-bits. Various portions of the address can be specifically allocated. For example, bits [0:3] can be allocated as offset bits; bits 4 through 5 (designated as [4:5]) can be allocated as word-select bits; bits [6:12] can be allocated as line-select bits; and bits [13:29] can be allocated as tag bits.

Given such 30-bit addresses, the multipurpose L2 cache 210 can be a four-way set-associative cache, for which the sets are selected by the line-select bits. Also, the word can be selected with the word-select bits. Since the example data structure has 2048-bit line sizes, the multipurpose L2 cache 210 can have four banks, with each bank having 1 RW 512-bit port, for up to four read/write (R/W) accesses for each clock cycle. It should be appreciated that, for such embodiments, the data in the multipurpose L2 cache 210 (including the shader program code, constants, thread scratch memories, the vertex cache (VC) content, and the texture surface register (T#) content) can share the same virtual memory address space.

An example embodiment is provided with reference to FIG. 3, which shows an multipurpose L2 cache 210 having four inputs 310, 320, 330, 340 and four outputs 315, 325, 335, 345. For this embodiment, one input (Xout CH0 310) receives 512-bit data from one channel (CH0) of the EU output 225 crossbar, and another input (Xout CH1 320) receives 512-bit data from another channel (CH1) of the EU output 225 crossbar. The third and fourth inputs (VC cache 330 and T# Req 340) each receive 512-bit-aligned vertex data from VC and T# registers, respectively. As shown in FIG. 3, the 512-bit data also has a 32-bit address associated with the data.

The outputs include a 512-bit output (Xin CH0 315) for writing data to the EU input 235 crossbar, and a 512-bit output (Xin CH1 325) for writing data to the EU input 235 crossbar. Also, 512-bit outputs (VC cache 335 and TAG/EUP 345) are provided for writing data to the VC and T# registers, respectively.

In addition to the four inputs 310, 320, 330, 340 and the four outputs 315, 325, 335, 345, the multipurpose L2 cache 210 includes an external R/W port 350 to the memory access unit 205. For some embodiments, the external write to the memory access unit 205 is given higher priority than other R=N requests. The EU load instruction loads 32/64/128/512-bit data, which is correspondingly aligned to 32/64/128/512-bit memory addresses. For the load instruction, the returned 32/64/128-bit data is replicated to 512 bits. The 512-bit data is masked by the valid pixel or vertex mask and channel mask when the data is written into the EU register file (also referred to herein as the “common register file” or “CRF”). Similarly, the EU store instruction (designated herein as “ST4/8/16/64”) stores 32/64/128/512-bit data, which is correspondingly aligned to 32/64/128/512-bit memory addresses.

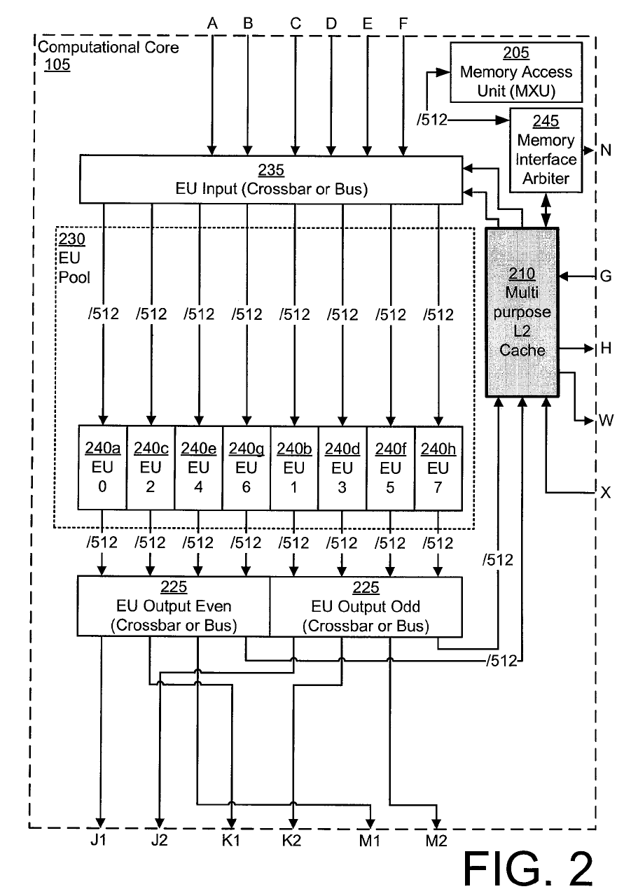

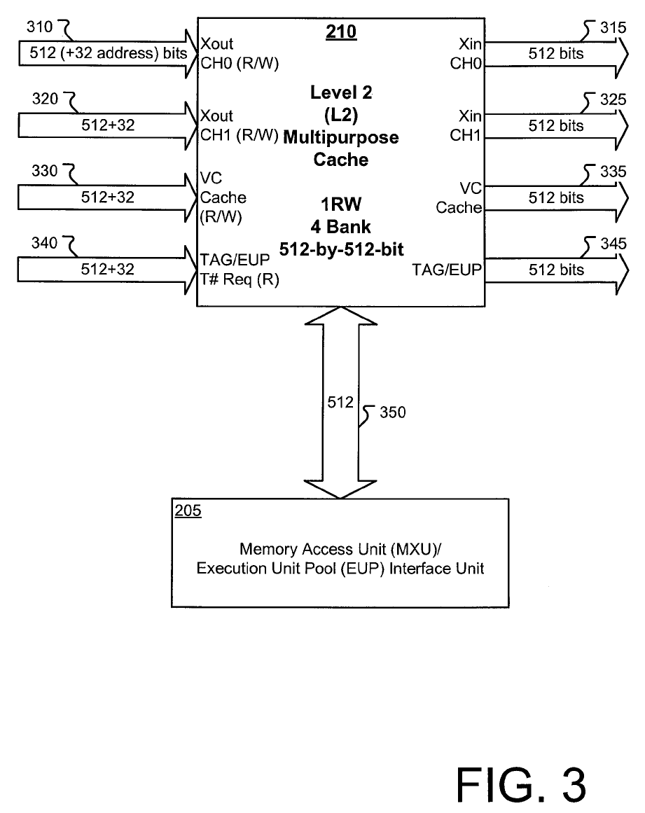

Given such data structures, all other read/write requests (e.g., instructions and constants from the EU, vertex data from the vertex cache, texture data from the T# registers, etc.) are aligned to 512-bit memory addresses. Various components of multipurpose L2 cache 210 are shown in greater detail with reference to FIGS. 4 and 5. Additionally, embodiments of various entry structures and/or data structures for use with multipurpose L2 cache 210 are shown with reference to FIGS. 6 through 10.

As shown in FIG. 6, the L2 tag data structure comprises a 1-bit vertical/horizontal flag (V/G), 1-bit valid flag (V), a 1-bit dirty flag (D6), a 17-bit tag (T6), and a 2-bit miss reference number (MR), all of which identify an address for a particular data set. In addition to these address bits, the data structure includes four 512-bit entries, totaling 2048 bits. The multipurpose L2 cache 210, for this nonlimiting embodiment, permits up to 512 entries.

FIG. 4 is a block diagram showing various components within the multipurpose L2 cache 210 of FIG. 3. The input data from Xout CH0 310 and Xout CH1 320 of FIG. 3 enter through their respective first-in-first-out (FIFO) stacks, correspondingly labeled in FIG. 4 as Xin CH0 FIFO 402 and Xin CH1 FIFO 404. Similarly, data that is entering through the VC cache input 330 is placed in the VCin FIFO 406, while the data entering through the T# request input 340 is placed in the T# request FIFO 408. These requests may have different data formats that define the restriction of request merging. Requests having the same data format (vertical or horizontal) may be merged.

The Xin CH0 FIFO 402 and the Xin CH1 FIFO 404 direct their respective incoming requests to request merge logic 410. The request merge logic 410 determines whether or not the incoming requests from these respective FIFOs should be merged. Components of the request merge logic 410 are shown in greater detail with reference to FIG. 5. The VCin FIFO 406 and the T# request FIFO 408 similarly direct their respective requests to corresponding request merge logic 412, 414.

The resulting outputs of the request merge logic 410, 412, 414 are conveyed to the hit test arbiter 416. The hit test arbiter 416 determines whether there is a hit or a miss on the cache. For some embodiments, the hit test arbiter 416 employs barrel shifters with independent control of shift multiplexers (MUXes). However, it should be appreciated that other embodiments can be configured using, for example, bidirectional leading one searching, or other known methods.

The results of the hit test arbitration from the hit test arbiter 416, along with the resulting outputs of the request merge logic 410, 412, 414, are conveyed to the hit-test unit 418. Up to two requests may be sent to the hit test unit 418 for every clock cycle. Preferably, the two requests should neither be on the same cache line nor in the same set. Also, the two requests should have the same data format. The hit test arbiter 416 and the various components of the hit test unit 418 are discussed in greater detail with reference to FIG. 5.

The multipurpose L2 cache 210 further comprises a missed write request table 420 and a missed read request table 422, which both feed into a pending memory access unit (MXU) request FIFO 424. The pending MXU request FIFO 424 further feeds into the memory access unit 205. The pending MXU request FIFO 424 is described in greater detail below, with reference to hit-test of the multipurpose L2 cache 210.

The return data from the MXU 205 is placed in a return data buffer 428, which conveys the returned data to an L2 read/write (R/W) arbiter 434. Requests from the hit test unit 418 and the read requests from the missed read request table 422 are also conveyed to the L2 R/W arbiter 434. Once the L2 R/W arbiter 434 arbitrates the requests, the appropriate requests are sent to multipurpose L2 cache RAM 436. The return data buffer 428, the missed read request table 422 420, the missed write request table 420 422, the L2 R/W arbiter 434, and the L2 cache RAM 436 are discussed in greater detail with reference to FIG. 5.

Given the four-bank structure of FIG. 6, the L2 cache RAM 436 outputs to four read banks 442, 444, 446, 448, which, in turn, output to an output arbiter 450. Preferably, the output arbiter 450 arbitrates in round-robin fashion the returned data of the read requests (Xin CH0 and Xin CH1), the VC, and the T#. Given that each entry may hold four requests, it can take up to four cycles to send data to the appropriate destination before the entry is removed from the output buffer.

FIG. 5 is a block diagram showing several of the components of FIGS. 3 and 4 in greater detail. Specifically, FIG. 5 shows the components related to the merge request and the hit test stages within multipurpose L2 cache 210. While the description of FIG. 5 presumes the data structure described above, it should be appreciated that the particular values for various registers can be varied without deviating from the spirit and scope of the inventive concept.

Recalling from the data structure described above, the incoming data to multipurpose L2 cache 210 comprises a 32-bit address portion and a 512-bit data portion. Given this, the incoming requests, Xin CH0 and Xin CH1, are each divided into two portions, namely, a 32-bit address portion and a 512-bit data portion. The 32-bit address portion for Xin CH0 is placed in the buffer address0 502, while the 512-bit Xin CH0 data is placed in the write data buffer 508. The write data buffer 508, for this embodiment, holds up to four entries. Similarly, the 32-bit address portion for Xin CH1 is placed in the buffer address1 504, and the 512-bit Xin CH1 data is placed in the write data buffer 508.

If there are any pending entries, then those pending entries are held in the pending request queue 506. In order to determine whether or not various requests (or entries) can be merged, the various addresses in the pending request queue 506 are compared with the addresses in buffers address0 502 and address1 504. For some embodiments, five comparators 510a . . . 510e are employed to compare different permutations of addresses. These comparators 510a . . . 510e identify whether or not the entries within those buffers can be merged.

Specifically, in the embodiment of FIG. 5, a first comparator 510a compares a current address for the Xin CH0 data (designated as “cur0” for simplicity), which is in the address0 buffer 502, with a previous address for Xin CH0 (designated as “pre0”), which is in the pending request queue 506. If the request cur0 matches with the entry pre0, then the request and the entry are merged by the merge request entries logic 512. The return destination ID and address of the merged entries are recorded in the pending request queue 506 by the update request queue logic 514.

A second comparator 510b compares a current address for the Xin CH1 data (designated as “cur1”), which is in the address1 buffer 504, with pre0. If cur1 matches pre0, then the merge request entries logic 512 merges cur1 with pre0, and the update request queue logic 514 updates the pending request queue 506 with the return destination ID and address of the merged entry or request.

A third comparator 510c compares cur0 with a previous address for Xin CH1 (designated as “pre1”). If cur0 and pre1 match, then the merge request entries logic 512 merges cur0 with pre1, and the update request queue logic 514 updates the pending request queue 506 with the return destination ID and address of the merged entry or request.

A fourth comparator 501d compares cur1 and pre1. If there is a match between cur1 and pre1, then cur1 and pre1 are merged by the merge request entries logic 512. The pending request queue 506 is then updated by the update request queue logic 514 with the return destination ID and address of the merged entry or request.

If none of the previous entries (pre0 and pre1) in the queue match the incoming request (cur0 and cur1), then a new entry is added into the queue.

A fifth comparator 510e compares cur0 and cur1 to determine if the two incoming requests match. If the two incoming requests are on the same cache line, then those incoming requests are merged by the merge request entries logic 512. In other words, if the two incoming requests match, then they are merged. The destination ID and address of the merged requests are updated in the pending request queue 506 by the update request queue logic 514.

Since the embodiment of FIG. 5 compares four addresses (cur0, cur1, pre0, pre1), the merge request entries logic 512 for this embodiment can hold up to four entries, each having a unique address. Also, it should be noted that, while the pending request queue 506 can hold up to four entries, only the first two entries are compared with current requests in the embodiment of FIG. 5. Thus, for this embodiment, if there are more than two entries in the queue, multipurpose L2 will stop receiving requests from the EU output (or crossbar) 225.

As noted above, multipurpose L2 cache 210 also includes a write data buffer 508, which holds write request data from the EU output 225. For the embodiment of FIG. 5, the write data buffer 508 holds up to four data entries. When the buffer is full, multipurpose L2 cache 210 stops receiving requests from the EU output 225. A pointer to the buffer is recorded in the request address entry, which is later used to load the write request data into the L2 cache RAM 436.

The multipurpose L2 cache 210 of FIG. 5 further comprises a hit test arbiter 416. The hit test arbiter 416 selects two valid entries (X0 and X1) from the Xin FIFOs 402, 404, one entry (VC) from the VCin FIFO 406, and one entry (TG) from the T# request input FIFO 408 as described in FIG. 4. This selection is based on an availability status from the previous cycle. Preferably, the two entries should not be selected from the same set. The result of arbitration is passed to the update request queue logic 514, and the selected entries are updated to include any request that has been merged in the current cycle. The entries are then removed accordingly from the pending request queue 506, and sent to the next stage for hit testing. The pending request queue 506 is updated to include merged requests in the current cycle and to remove entries that are sent to the next stage for hit testing.

As described with reference to FIG. 4, the hit test arbitration scheme can employ barrel shifters with independent control of shift MUXes, but can also be implemented using other known techniques. There can be up to two requests that are sent to the hit test unit 418 at every cycle. Preferably, the two requests should neither be on the same cache line nor in the same set. Since, for this embodiment, there is only one request for each set, no complicated least-recently used (LRU) and replacement scheme are necessary. Bits [6:12] of the 30-bit address can be used as an index to look up four tags from an L2 tag RAM 520, and the 17 most significant bits (MSBs) of the address can be compared with the four tags to find a match.

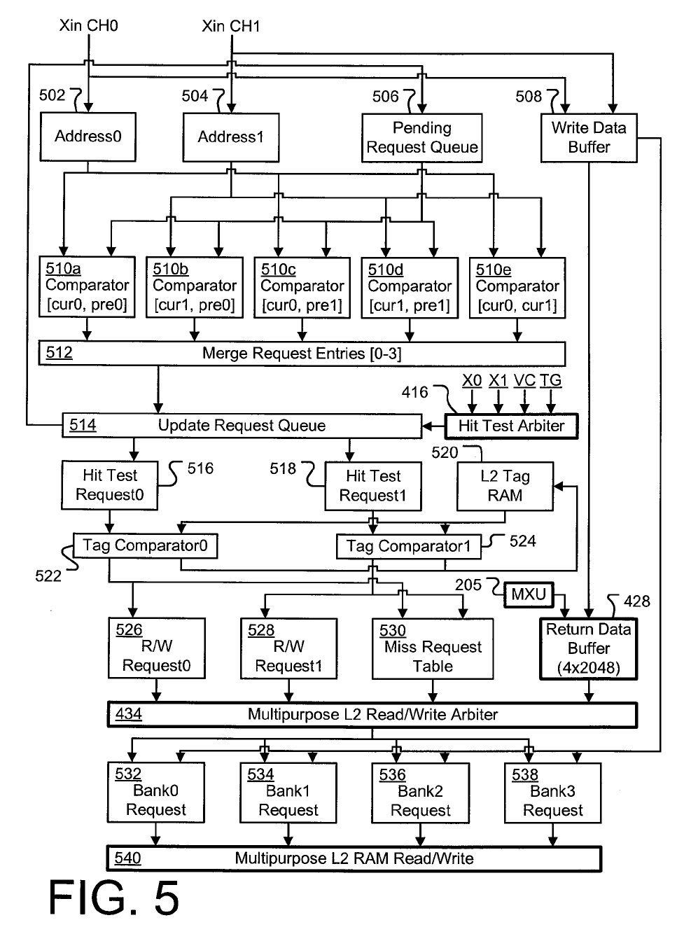

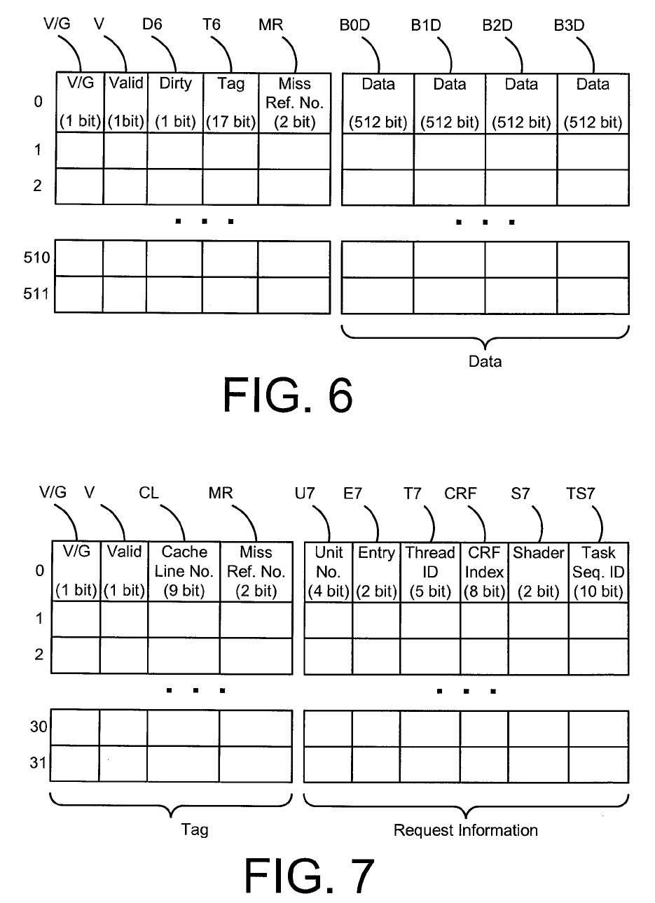

If there is a hit on multipurpose L2 cache 210, then the address is sent to the next stage along with the word selections, offsets, return destination IDs, and addresses of up to four requests attached to the hit test entry. If there is a miss on multipurpose L2 cache 210, then the line address and other request information is written into a 64-entry miss request table 530. Similarly, if there is a hit-on-miss (described below), then the line address and other request information is written into the 64-entry miss request table 530. Data structures for both a missed read request table 422 and a missed write request table 420 are discussed in greater detail with reference to FIGS. 7 and 8, respectively. This hit test arbitration scheme preferably allows for pipeline stalls if there is any back-pressure from subsequent stages within the multipurpose L2 cache 210.

FIG. 7 is an illustration of a structure for an entry in a missed read request table 422. The missed read request table 422, within the L2 cache 210, records misses occurring in multipurpose L2 cache 210. In that regard, the multipurpose L2 cache 210 can continuously receive requests, despite the existence of a read miss on the multipurpose L2 cache 210. As described in greater detail below, a missed read request is placed in the missed read request table 422, and a main memory request is issued. When the main memory request returns, the missed read request table 422 can be searched to find the return address. Thus, the new return address is obtained without storing the cache.

Unlike the missed read request table 422, conventional caches often employ a latency FIFO. Such latency FIFOs place all requests within the FIFO. Thus, regardless of whether or not there is a hit on the cache, all of the requests are directed through the latency FIFO in conventional caches. Unfortunately, in such conventional latency FIFOs, all requests will wait for the entire cycle of the latency FIFO regardless of whether or not those requests are hits or misses. Thus, for a latency FIFO (which is about 200 entries deep), a single read miss can result in undesired latency for subsequent requests. For example, if there is a first read miss on cache line 0, but read hits on cache lines 1 and 2, then, for a latency FIFO, the read requests on cache lines 1 and 2 must wait until the read request on cache line 0 clears the latency FIFO before the cache realizes that there is a read miss.

The missed read request table 422 permits pass-through buffering of hit read requests and/or an out-of order L2 cache access, despite the presence of missed read requests. Thus, when there is a read miss on the multipurpose L2 cache 210, that read miss is buffered through the missed read request table 422, and all other read requests are passed through. For example, if there is a first read miss on cache line 0, but read hits on cache lines 1 and 2, then, for the missed read request table 422, the read miss on cache line 0 is buffered to the missed read request table 422, while the read requests on cache lines 1 and 2 are passed through the L2 cache 210. Specific embodiments of the missed read request table 422 are provided below.

In the embodiment of FIG. 7, the missed read request table 422 permits 32 entries. Each entry is divided into a 13-bit tag and 31-bit request information describing the client (process and thread in computational core). The tag includes a 1-bit vertical/horizontal flag (V/G), 1-bit valid/invalid flag (V), a 9-bit cache line number (CL), and a 2-bit miss reference number (MR). The request information, for this embodiment, includes a 4-bit destination unit ID number (U7), a 2-bit entry type (E7), a 5-bit thread ID (T7), an 8-bit register file index (CRF), a 2-bit shader information (S7), and a 10-bit task sequence ID (TS7).

If there is a read miss in the multipurpose L2 cache 210, the missed read request table 422 is searched, and a free entry is selected to store the CL and other information related to the request (e.g., U7, E7, T7, CRF, S7, TS7, etc.). In addition to storing the CL and other related information, the 2-bit miss pre-counter (MR) of the selected cache line is incremented, and the value of the counter is copied into the table entry.

If there is a read hit in the multipurpose L2 cache 210, and the pre-counter and post-counter are not equal (“hit-on-miss”), then a new entry is created in the missed read request table 422. For the hit-on-miss, the pre-counter of the selected cache line is not incremented.

If there is a read hit on the L2 cache 210, and the pre-counter equals the post-counter (“hit”), then no new entry is created in the missed read request table 422, and the request is sent directly for read by the L2 cache RAM 436.

FIG. 8 is an illustration of a structure for an entry in a missed write request table 420. Unlike a missed read request, a missed write request is relatively large, since a write request includes both an address and corresponding data to be written. Due to the size of the write request, there is a substantial cost associated with storing all of the missed write requests. Conversely, if too little is buffered, then problems associated with stolen cache data may arise.

Conventional caches typically provide for write-through, which accesses external memory to place the data associated with the write miss. Unfortunately, such write-through mechanisms result in added data traffic to the memory. This added data traffic increases inefficiency of memory subsystem.

Unlike conventional write-through mechanisms, the missed write request table 420 of FIG. 8 permits storage of the address of the missed write request within the multipurpose L2 cache 210 itself instead of special write-through buffer, along with a mask that flags that data as being dirty. Thus, the data is locally kept on the L2 cache 210. When the data is flagged as dirty, that dirty line is replaced with another write request having the same data. For example, when a mask for a dirty line is stored in the multipurpose L2 cache 210, that mask is compared with subsequent write requests during the hit-test stage. If the stored mask matches a write request, then the new data replaces the data from the previously missed write request. Specific embodiments of the missed write request table 420 are provided below.

In the embodiment of FIG. 8, the missed write request table 420 permits 16 entries. Each entry is divided into a 13-bit tag and a 64-bit write mask. The 13-bit tag of the missed write request table 420, for this embodiment, is similar to the 13-bit tag of the missed read request table 422. In that regard, the 13-bit tag includes a 1 bit vertical/horizontal flag (WG), 1-bit valid/invalid flag (V), a 9-bit cache line number (CL), and a 2-bit miss reference number (MR). The write mask, for this embodiment, includes four 16-bit masks, one for each of the banks (bank 0 mask (B0M), bank 1 mask (B1M), bank 2 mask (B2M), and bank 3 mask (B3M)).

If there is a write miss in the multipurpose L2 cache 210, then the missed write request table 420 is searched, and a free entry is selected to store the cache line address (CL) and a corresponding update write mask. The 2-bit miss pre-counter (MR) of the selected cache line is incremented, and the value of the counter is copied into the missed write request table 420.

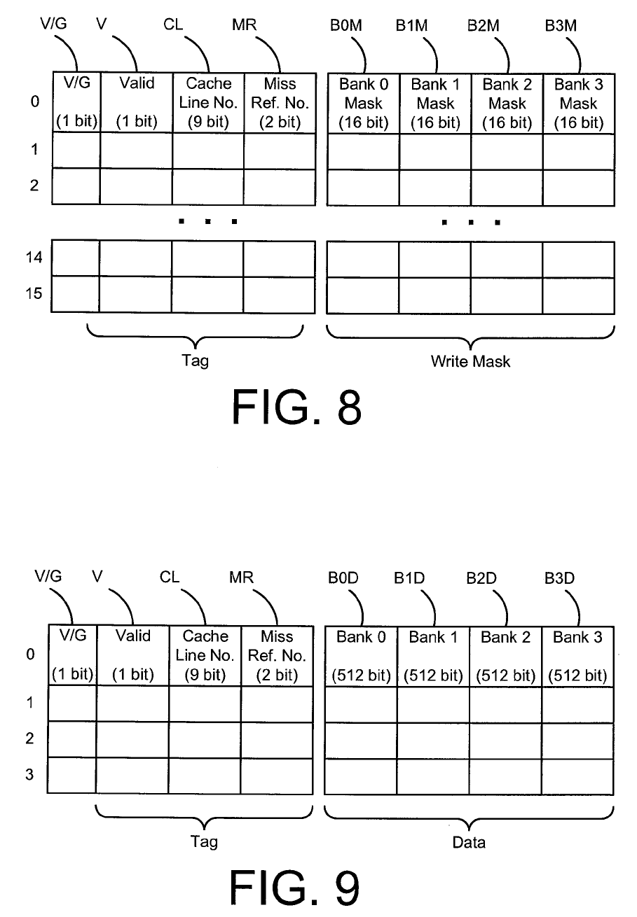

If the miss pre-counter is equal to the miss post-counter before the increment (“first-write-miss”), then the write data is sent to the L2 cache RAM 436 directly, along with the original write mask. If the miss pre-counter is not equal to the miss post-counter before the increment (“miss-on-miss”), then the return data buffer 428 is searched to find a free entry to hold the write data. The structure of the return data buffer 428 is described in greater detail with reference to FIG. 9, below.

If there is a write hit in the multipurpose L2 cache 210, and the pre-counter is unequal to the post-counter (“hit-on-miss”), then the missed write request table 420 is searched to find a matched entry with the same cache line address (CL) and miss count (MR). If such an entry is found, then the update write mask is merged with the original write mask that is found in the missed write request table 420.

Concurrent with the searching of the missed write request table 420, the return data buffer 428 is searched for an entry with the same cache line address (CL) and miss count (MR). If such a match is found in the return data buffer 428 (“hit-on-miss-on-miss”), then the write data is sent to the return data buffer 428. However, if no such match is found in the return data buffer 428 (“hit-on-miss”), then the write data is sent to the L2 cache RAM 436, along with the merged update write mask.

If there is a write hit in the multipurpose L2 cache 210, and the pre-counter equals the post counter (“write hit”), then the write data is sent to the L2 cache RAM 436 directly, along with the original write mask. For all write hit requests, the miss pre-counter (MR) is not incremented.

For some embodiments, if a replaced line in a read miss or a write miss is dirty, then the hit test unit 418 first issues a read request to read the dirty line from the MXU 205. Thereafter, the write data is sent during the next cycle.

After the hit test arbitration stage, various entries and requests are arbitrated and sent to the multipurpose L2 cache RAM 436. These entries include read/write requests from the hit test stage, read requests from a miss request FIFO, and write requests from the MXU 205. In the event that requests from different sources go to the same bank in the same cycle, the MXU write request has the highest priority in this embodiment. Also, for this embodiment, the miss request FIFO has the second highest priority, and the hit test results have the lowest priority. As long as requests from the same source are directed to different banks, those requests can be arranged out of order in order to maximize throughput.

For some embodiments, the output arbitration on the return data can be performed in a round-robin fashion by the output arbiter 450. For such embodiments, the returned data can include the read requests from the crossbar (Xin CH0 and Xin CH1), the read request from the vertex cache client (VC), and the read request from the T# registers client (TAG/EUP). Since, as noted above, each entry can hold up to four requests, it can take up to four cycles to send the data to the appropriate destinations before the entry is removed from the output buffer.

Upon a cache miss, a request to the MXU 205 is sent to the pending MXU request FIFO 424. For some embodiments, the pending MXU request FIFO 424 includes up to 16 pending request entries. In the embodiments of FIGS. 4 and 5, the multipurpose L2 cache 210 permits up to four write requests (out of the 16 total pending request entries) to the memory. For read requests, the 9-bit return L2 cache line address (LC) and the 2-bit miss reference count number (MR) are sent to the MXU 205, along with the virtual memory address. The LC and MR can later be used to search for the entry in the missed read request table 422, when the data is returned from the MXU 205.

FIG. 9 is an illustration of a structure for an entry in the return data buffer 428. In the embodiment of FIG. 9, the return data buffer 428 includes up to four slots (0, 1, 2, 3). Each of the four slots is divided into a 13-bit tag and a 2048-bit data portion. The 13-bit tag of the return data buffer 428, for this embodiment, is similar to the 13-bit tag for both the missed read request table 422 and the missed write request table 420. In that regard, the 13-bit tag includes a 1-bit vertical/horizontal flag (VIG), 1-bit valid/invalid flag (V), a 9-bit cache line number (CL), and a 2-bit miss reference number (MR). The 2048-bit data portion, for this embodiment, includes four 512-bit banks (bank 0 (B0D), bank 1 (B1D), bank 2 (B2D), and bank 3 (B3D)). For some embodiments, the first slot (0) is used for bypass, while the remaining slots (1, 2, 3) are used for miss-on-miss requests.

Upon an L2 cache write miss, if the pre-counter and post-counter numbers are not equal prior to increment (“miss-on-miss”), then the return data buffer 428 is searched to find a free entry to hold the partial write data. Upon an L2 cache read miss-on-miss, the return data buffer 428 is searched to find a free entry to receive the returned data from the MXU 205. The selected entries are marked with the cache address line number (CL) and a miss pre-count (MR). If all three slots (1, 2, 3) for miss-on-miss requests have been allocated, then the hit-testing stage will, for some embodiments, be stopped.

When returned data from the MXU 205 arrives in the return data buffer 428, the three slots (1, 2, 3) are searched to find a match with the same cache address line number (CL) and miss count (MR). If none of those match the incoming returned data, then the incoming returned data is stored in the bypass slot (0). That stored data is then sent to the L2 cache RAM 436 during the next cycle, along with the update write mask specified in the missed write request table 420. If, however, a match is found, then the data is merged with the entries in the buffer according to the update write mask for a write-miss-initiated memory request. It should be noted that the data is filled in the buffer directly for a read-miss-initiated memory request.

For some embodiments, the order written to the L2 cache 210 is kept as only for the data that has the same cache address. Other data for different cache lines is written into the L2 cache when that data becomes ready.

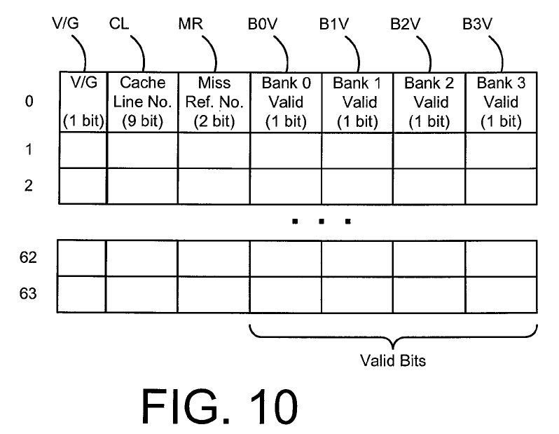

FIG. 10 is an illustration of a structure for an entry in a return request queue 430. In the embodiment of FIG. 10, the return request queue 430 includes up to 64 entries. Each of the 64 entries, for this embodiment, includes a 9-bit cache line number (CL), a 2-bit miss reference number (MR), and four valid bits (B0V, B1V, B2V, B3V), one for each of the four data banks.

When a data entry is read from the return data buffer 428 and sent to the L2 cache RAM 436, a new entry is added to the return request queue 430 to store the cache line address (CL) and the miss count (MR). Additionally, all of the valid bits (B0V, B1V, B2V, B3V) are initialized, for example, by setting all valid bits to “1.”

There are four return request control state machines 432, one for each bank. Each return request control state machine 432 reads the first table entry for which the valid bit has been correspondingly set. For example, the first state machine, which corresponds to the first bank, reads the first entry in which B0V is set to “1%”; the second state machine reads the first entry in which B1V is set to “1”; and so on. At each cycle, the state machines then use the cache line address (CL) and the miss count (MR) to search the missed read request table 422 for a match. If there is a match, then the matched entry is processed and the request is sent to the L2 R/W arbiter 434.

For some embodiments, the request that is sent to the L2 R/W arbiter 434 has a lower priority than a write request from the return data buffer 428, but a higher priority than a request from the hit test unit 418. After the request to the L2 R/W arbiter 434 is granted access to the L2 cache RAM 436 for read, the entry is released and marked as invalid (bit set to “0”).

After all matched entries in a given bank (identified by CL and MR) of the missed read request table 422 are processed, the valid bits of the corresponding entries in the return request queue 430 are set to “0.” When all four valid bits of an entry are reset to “0,” the miss post-counter for the line is incremented, and the entry in the return request queue 430 is removed. In other words, when the pending request for all four banks of a particular line are served, the miss post-counter of the line is incremented, and the entry in the return queue 430 is removed.

The return data buffer 428 is searched with the updated miss counter value (MR). If a match is found in the slots for the miss-on-miss requests, then the data entry of the slot is moved into the L2 cache RAM 436, and a new entry is added to the return request queue 430.

As shown with reference to FIGS. 1 through 10, the merging of requests within the L2 cache 210 permit greater processing efficiency, insofar as duplicative requests are reduced from the request queue.

Additionally, the missed read request table 422 and the missed write request table 420 permit faster processing compared to conventional latency FIFOs that suffer from latency problems.

To improve the efficiency of the stream graphics processor having a memory subsystem, some embodiments may provide for the merging of memory access requests from multiple clients with different data formats. For those embodiments, requests are compared to determine whether there is a match between the requests. If the requests match, then the requests may be merged, and the return destination identifier (ID) and address may be recorded in a pending request queue. By merging requests that match, the memory subsystem may increase its efficiency by not queuing duplicative requests.

In some embodiments, a memory access request may be received from one of the clients, and logic may determine whether the received request can result in a hit on one of the caches. If the received request results in a hit on the cache, then the received request may be serviced according to the data formats requested by the client. Conversely, if the received request does not result in a hit (e.g., miss, miss-on-miss, hit-on-miss, etc.), then information related to the received request may be stored in a missed read request table that may be configured to process requests from different types of stream graphics processing clients. Latency within the memory subsystem may be reduced by providing a missed read request table, which may buffer cache read misses and may permit cache read hits to pass through. In some embodiments, missed read requests may be stored in a missed read request table, while missed write requests may be stored in a missed write request table with data type descriptors and determined data communication actions. Similar to the missed read request table, the missed write request table may reduce latency in the event of a write miss.

Furthermore, due to the depth of a virtual stream graphics processing pipeline, hit tests may be implemented differently from implementations on a traditional CPU. For example, a look-ahead hit test (also called a hit test on the future) may be implemented such that the look-ahead hit test and the actual cache read may happen at different stages of the virtual pipeline, and the multipurpose L2 cache 210 may inherit some or all of these functionalities. The multipurpose L2 cache 210 may also support an immediate hit on the current cache content (real hit, not hit in the future), so that a read request may be resolved sooner without going through the latency FIFO (miss table) and providing minimal stall for the execution control and datapath 150a. In this mode, the multipurpose L2 cache 210 may act as a L1 cache for indexed random access to data stored in a horizontal data format and/or a vertical data format.

In addition, there may be several special techniques for supporting multiple stream processing of a multiple format data flow. For example, in some cases, stalls may occur in the virtual stream processing pipeline, and the memory subsystem may remedy these stalls by using a transparent mechanism for data spills and refetches to/from the multipurpose L2 cache 210 as well as to/from the frame buffer 86 or the system memory 18.

Another feature may be a flush and/or invalidation of data in the specialized L1 cache pool 155b. In some embodiments, the multipurpose L2 cache 210, stream cache and instruction L1 cache 161b may be invalidated or flushed according to a flush command. The flush command may provide an address-based technique to handle a cache invalid or flush of an entry in one of the caches mentioned above. The address-based technique may reduce the likelihood of invalidating or flushing the entire cache during a context change. The stream cache and instruction L1 cache 161b may be read-only caches, and read-only caches may be invalidated but not flushed.

Data forwarding to the specialized L1 cache pool 155b may be combined with software fence/wait commands to resolve CPU/GPU data access hazards. Internal fence and/or wait, which may also be referred to as internal graphics pipeline synchronization, may be utilized by a GPU so as to deal with any read-after-write or premature write hazards without having to drain the entire graphics pipeline. U.S. Pat. App. Pub. No. 2007/0091102 entitled “GPU Pipeline Multiple Level Synchronization Controller Processor and Method,” which is hereby incorporated by reference in its entirety, illustrates one nonlimiting example of fence and wait commands to resolve data access hazards.

In some embodiments, among others, a computing system 12 may include a system memory 18, as shown in the nonlimiting example in FIG. 1A, configured to store data in a first data format. The computing system 12 may also include a computational core 105, as shown in the nonlimiting example in FIG. 1C, comprising a plurality of execution units (EU) 240a, 240b. The computational core 105 may be configured to request data from the system memory 18 and to process data in a second data format. As illustrated in the nonlimiting example in FIG. 1B, each of the plurality of EU 240a, 240b may include an execution control and datapath 150a, 150b and a specialized L1 cache pool 155a, 155b for storing data in the first data format and the second data format. Each execution control and datapath 150a, 150b may comprise a SIMD superscalar stream processing core, and each specialized L1 cache pool 155a, 155b may comprise a constants cache 157a, a temporal register 156a, an instruction cache 161a, a texture (t#) description and sampler (s#) description cache 158a, and a vertex cache 162a.

Further, the computing system 12 may include a multipurpose L2 cache 210 in communication with the each of the plurality of EU 240a, 240b and the system memory 18 as depicted in FIG. 1B. The multipurpose L2 cache 210 may be configured to store data in the first data format and the second data format. Also, the multipurpose L2 cache 210 may be configured to provide communication and synchronization between the multipurpose L2 cache 210, the specialized L1 cache pool 155a, and the system memory 18.

The computing system 12 may also include an orthogonal data converter 185 in communication with at least one of the plurality of EU 240a, 240b and the system memory 18 as illustrated in FIG. 1B. The orthogonal data converter 185 may be configured to convert data sent to and from the execution control and datapath 150a. The orthogonal data converter 185 may provide conversion from the first data format to the second data format as well as conversion from the second data format to the first data format. The first data format may be a format that is orthogonal to the second data format. For example, the first data format may be a horizontal data format whereas the second data format may be a vertical data format. The data request may comprise a data format flag (V/G) which may indicate whether the data format of the data request is the first data format or the second data format. The computing system 12 may comprise another orthogonal data converter 186 configured to provide conversion of data related to the data request.

The multipurpose L2 cache 210 may further comprise logic configured to determine whether a hit on the multipurpose L2 cache 210 results from the multipurpose L2 cache read request. The multipurpose L2 cache read request is a data request. The multipurpose L2 cache 210 may also include a missed read request table 422 configured to store data related to the multipurpose L2 cache read request responsive to a determination that no hit on the multipurpose L2 cache 210 results from the multipurpose L2 cache read request.

In some embodiments, the multipurpose L2 cache 210 may comprise an input configured to receive the data request from the execution control and datapath 150a or a hardware client. The multipurpose L2 cache 210 may also comprise hit test logic configured to determine whether the received data request results in a hit on the multipurpose L2 cache 210. Further, the multipurpose L2 cache 210 may comprise a missed request table configured to store an entry related to the received data request. The entry may be stored in response to the received data request not resulting in a hit on the multipurpose L2 cache 210. The multipurpose L2 cache 210 may also comprise output logic configured to service the received data request in response to the received data request resulting in a hit on the multipurpose L2 cache 210. The entry in the missed request table may comprise a field (CL) to identify a cache line associated with the missed request, a field (MR) to identify a miss reference number associated with the missed request, a field (U7) to identify a destination associated with the missed request, and a field (V) to identify whether the missed read request is valid.

The missed request table may be a missed read request table 422, such as the one depicted in the nonlimiting example in FIG. 4, for buffering a missed read request. The entry in the missed read request table 422, such as the one illustrated in the nonlimiting example in FIG. 7, may comprise a field (E7) to identify an entry type associated with the missed read request, a field (T7) to identify a thread associated with the missed read request, and a register file index (CRF) associated with the missed read request.

The missed request table may be a missed write request table 420, such as the one depicted in FIG. 4, for buffering a missed write request. The missed write request table 420 may comprise a mask that corresponds to data from the missed write request.

The computing system 12 may comprise logic configured to flush an entry of the specialized L1 cache 155a according to a flush command. The flush command may include the address of the entry in the specialized L1 cache 155a to be flushed. The computing system 12 may comprise logic configured to flush an entry of the multipurpose L2 cache 210 according to a flush command. The flush command may include the address of the entry in the multipurpose L2 cache 210 to be flushed.

In some embodiments, the data request may be a first multipurpose L2 cache read request. Also, the computing system 12 may comprise logic configured to merge the first multipurpose L2 cache read request with a second multipurpose L2 cache read request directed to the same address with the same data format flag.

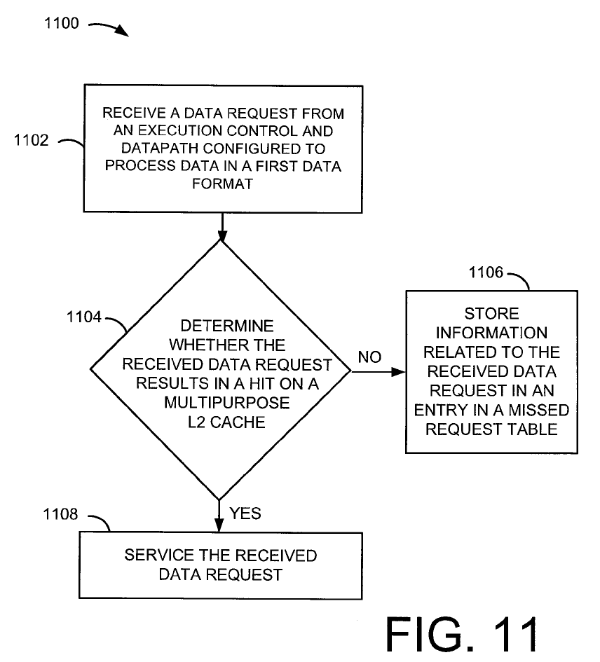

In some embodiments, such as the nonlimiting example depicted in FIG. 11, a method 1100 may include blocks 1102, 1104, 1106, and 1108. In block 1102, a data request is received from an execution control and datapath configured to process data in a first data format. An execution unit may comprise the execution control and datapath. In block 1104, whether the received data request results in a ht on a multipurpose L2 cache is determined. The multipurpose L2 cache is configured to store data in the first data format and a second data format. In block 1106, information related to the received data request is stored in an entry in a missed request table in response to a determination that the received data request does not result in a hit on the multipurpose L2 cache. In block 1108, the received data request is serviced in response to a determination that the received data request results in a hit on the cache. The servicing of the received data request also includes orthogonally converting the requested data related to the received data request.

In some embodiments, the method 1100 may further comprise flushing the entry according to an address-based flush command. The method 1100 may further comprise storing a tag related to the data format of the data requested by the received data request.

The various logic components are preferably implemented in hardware using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Although exemplary embodiments have been shown and described, it will be clear to those of ordinary skill in the art that a number of changes, modifications, or alterations to the disclosure as described may be made. For example, while specific bit-values are provided with reference to the data structures in FIGS. 6 through 10, it should be appreciated that these values are provided merely for illustrative purposes. In that regard, the particular configuration of these systems can be altered, and corresponding changes in the bit-values can be implemented to accommodate such configurations.

Additionally, while four-bank embodiments are shown above, it should be appreciated that the number of data banks can be increased or decreased to accommodate various design needs of particular processor configurations. Preferably, any number that is a power of 2 can be used for the number of data banks. For other embodiments, the configuration need not be limited to such numbers.

All such changes, modifications, and alterations should therefore be seen as within the scope of the disclosure.

What is claimed is:

1. A computing system comprising:
a system memory configured to store data in a first data format;
a computational core comprising a plurality of execution units (EU), the computational core being configured to request data from the system memory and to process data in a second data format, each of the plurality of EU comprising an execution control and datapath and a specialized L1 cache pool for storing data in the first data format and the second data format;
a multipurpose L2 cache in communication with the each of the plurality of EU and the system memory, the multipurpose L2 cache being configured to store data in the first data format and the second data format; and
an orthogonal data converter in communication with at least one of the plurality of EU and the system memory, the orthogonal data converter being configured to convert data sent to and from the execution control and datapath.

2. The computing system of claim 1, wherein the execution control and datapath comprises a SIMD superscalar stream processing core.

3. The computing system of claim 1, wherein the specialized L1 cache pool comprises a vertex cache, a constant cache, a temporal register cache, an instruction cache, and a texture and sampler description cache.

4. The computing system of claim 1, wherein the orthogonal data converter provides conversion from the first data format to the second data format and conversion from the second data format to the first data format.

5. The computing system of claim 4, wherein the first data format is a data format that is orthogonal to the second data format.

6. The computing system of claim 1, wherein the data request comprises a data format flag.

7. The computing system of claim 6, wherein the data request is a first multipurpose L2 cache data request; and the computing system further comprises logic configured to merge the first multipurpose L2 cache data request with a second multipurpose L2 cache data request directed to the same address with the same data format flag.

8. The computing system of claim 1, the multipurpose L2 cache further comprising logic configured to provide communication and synchronization between the multipurpose L2 cache, the specialized L1 cache pool and the system memory.

9. The computing system of claim 1, wherein the data request is a multipurpose L2 cache read request;
wherein the multipurpose L2 cache further comprises:
logic configured to determine whether a hit on the multipurpose L2 cache results from the multipurpose L2 cache read request; and
a missed read request table configured to store data related to the multipurpose L2 cache read request responsive to a determination that no hit on the multipurpose L2 cache results from the multipurpose L2 cache read request.

10. The computing system of claim 1, further comprising another orthogonal data converter configured to provide conversion of data related to the data request.

11. The computing system of claim 1, wherein the multipurpose L2 cache comprises:
an input configured to receive the data request from the execution control and datapath or a hardware client;
hit test logic configured to determine whether the received data request results in a hit on the multipurpose L2 cache;
a missed request table configured to store an entry related to the received data request, the entry being stored in response to the received data request not resulting in a hit on the cache; and
output logic configured to service the received data request in response to the received data request resulting in a hit on the multipurpose L2 cache.

12. The cache of claim 11, wherein the missed request table is a missed read request table to buffer a missed read request.

13. The cache of claim 12, wherein an entry in the missed read request table comprises a field to identify an entry type associated with the missed read request, a field to identify a thread associated with the missed read request, a field to identify a task sequence associated with the missed read request, and a register file index associated with the missed read request.

14. The cache of claim 11, wherein the missed request table is a missed write request table to buffer a missed write request.

15. The cache of claim 14, wherein the missed write request table comprises a mask that corresponds to data from the missed write request.

16. The cache of claim 11, wherein an entry in the missed request table comprises a field to identify a cache line associated with the missed request, a field to identify a miss reference number associated with the missed request, a field to identify a destination associated with the missed request, and a field to identify whether the missed read request is valid.

17. The computing system of claim 11, further comprising logic configured to flush an entry of the specialized L1 cache according to a flush command, wherein the flush command includes the address of the entry in the specialized L1 cache to be flushed.

18. The computing system of claim 11, further comprising logic configured to flush an entry of the multipurpose L2 cache according to a flush command, wherein the flush command includes the address of the entry in the multipurpose L2 cache to be flushed.

19. A method comprising the steps of:
receiving a data request from an execution control and datapath configured to process data in a first data format, an execution unit comprising the execution control and datapath and a specialized L1 cache pool associated with the execution control and datapath;
determining whether the received data request results in a hit on a multipurpose L2 cache, the multipurpose L2 cache being configured to store data in the first data format and a second data format;
storing information related to the received data request in an entry in a missed request table in response to determining that the received data request does not result in a hit on the multipurpose L2 cache; and
servicing the received data request in response to determining that the received data request results in a hit on the cache, wherein servicing the received data request further includes orthogonally converting requested data related the received data request.

20. The method of claim 19, further comprising flushing the entry according to an address-based flush command.

21. The method of claim 19, further comprising storing a tag related to the data format of the data requested by the received data request.
